(19) United States
(12) Patent Application Publication
(10) Pub. No.: US 2014/0096736 A1
(43) Pub. Date: Apr. 10, 2014

(54) PISTON RING WITH COMPOSITE COATING

(71) Applicants: Dirk Bärenreuter, Odenthal (DE); Christoph Bradl, Burscheid (DE)

(72) Inventors: Dirk Bärenreuter, Odenthal (DE); Christoph Bradl, Burscheid (DE)

(21) Appl. No.: 14/122,121

(22) PCT Filed: May 24, 2012
(86) PCT No.: PCT/EP2012/059708

§ 371 Date: Nov. 25, 2013

(30) Foreign Application Priority Data
May 25, 2011 (DE) 102011076453.4

(51) Int. Cl. F02F 5/00

(52) U.S. Cl. CPC F02F 5/00
USPC 123/193.6

(57) ABSTRACT

A piston ring has a piston ring basis element, of a material having a first thermal expansion coefficient, a wear protection layer, arranged on a radially outer face of the piston ring, that is made of a material having a second thermal expansion coefficient being smaller than the first thermal expansion coefficient, and including an intermediate layer, arranged between the piston ring basis element and the wear protection layer. The intermediate layer is made of a material having a third thermal expansion coefficient, that is bigger than the first thermal expansion coefficient.

The present invention generally relates to piston rings for piston engines and more specifically to piston rings for internal combustion engines.

It is known for a long time to coat piston rings on the outside with different run-in and/or wear-protection coats, for improving the tribological pairing of piston ring/inner wall of the cylinder.

Each coating or layer, on the outer side of a piston ring with different run-in and wear-protection coating that have a different thermal expansion coefficients than the basic material, involves a kind of bimetal effect during a transition between normal and operating temperature. This bimetal effect has an impact on the contact pressure and the distribution of the contact pressure of the piston ring onto the running surface of the cylinder. The bimetal effect is superimposed to the effects of standard thermal expansion and potential effects of the warming to the material strength.

Completely coated piston rings are already known in the state of the art. Additionally, piston rings are known that are provided with a wear protection coating on the inner and outer sides, and that have been coated with coating methods allowing to coat the inner and outer side of a piston ring. A coating of the inner side or rather inner surface of piston rings is generally considered as waste of generally expensive coating material, as the inner surface of a piston ring is not subjected to load.

From documents DE 7608044 U1, JP 2005351460 A, JP 2008057671 A and GB440 different piston rings are already known that use bimetal structures.

There are different known publications that deal with the topic of piston rings. The EP 2206937 (A1) discloses a piston ring having an integrated compression spring, the US 2010140880 (A1) discloses a piston ring having a coated upper and lower surface, and the US 2010127462 (A1) pertains to a piston ring having a multilayer coating on the running surface/the outer surface of the piston ring.

On the other hand the DE 102005063123 (B3) discloses a piston ring having a layer on the running surface/the outer surface of the piston ring. EP 2183404 (A1) also shows a piston ring having a coating on the outer surface. EP 2119807 (A1) pertains to a piston ring having a wear protection coating on the outer surface. The WO2008151619 (A1) discloses a piston ring configured to tilt in the piston ring groove.

With known piston rings having a coating on the outer surface it may happen that undesired bimetal effects occur, wherein under rising temperatures an outer coating of the piston rings expands in a different way than the material of the piston ring itself, causing that the tension or the resulting radial pressure distribution of the piston ring may be affected. Usually, these effects are negligible, as the coating usually only makes up a negligible part of the cross sectional area of the piston ring and the strength of the coating is only slightly higher than the strength of the material of the piston ring.

With modern wear protection coatings it may happen that due to the increasing hardness of the wear protection coatings bimetal effects may occur on piston rings, which may cause the radial pressure exerted by the piston ring and the resulting radial pressure distribution of the piston ring to vary with rising temperatures.

This effect does not occur with uncoated or completely coated piston rings.

The object of the present invention resides in providing a piston ring with a wear protection coating having an improved radial pressure distribution.

The conventional approach for removing a bimetal effect may reside in interrupting the coating or with coating only parts of the outer surface. It may also be expected that an artisan changes the form of the piston ring in a cold state so that the change due to the bimetal effect is already considered in the design of the piston ring. To avoid deviations in the radial pressure distribution of the piston ring, an artisan would form it in a way that the piston ring shows the desired radial pressure distribution at operating temperature with the bimetal effect.

The bimetal effect especially makes an impact on the area of the clearance/the gap the piston ring, that is, the ends of the ring at the gap are pressed towards an outer direction. This effect is known as “end scratching” or “end biting” (Stoβbeiβen). This effect leads to a much higher load on the ring ends than on the rest of the circumference of the piston ring. The wear protection layer may be abraded in an area at the end of the piston ring, so that in this area there is danger of galling of the piston or the piston ring.

Up to now this effect has been avoided by pre-forming the ring during manufacture such that they only exert low pressure in the area of the ends/the gap of the piston ring. However, this measure proved to be not sufficient.

According to the invention the bimetal effect is avoided by applying an intermediate layer/coating between a wear protection layer and the piston ring. The intermediate layer has dimensions and a thermal expansion coefficient that are selected in a way to significantly reduce or remove the bimetal effect between a wear protection layer and the piston ring.

Due to the greater hardness and robustness of the wear protection layer the wear protection layer has a lower thermal expansion coefficient than the material of the piston ring. Due to the wear protection layer the piston ring bends outwardly by the bimetal effect when the temperature rises, which has the greatest impact in the area of the gap.

If an intermediate layer or coating having a higher thermal expansion coefficient than the wear protection layer and the material of the piston ring is applied therebetween, both bimetal effects even out in the ideal case. This is possible as the dimension of thickness of the piston ring significantly exceeds the thicknesses of the two other layers. Thus, the wear protection layer and the intermediate layer are lying on one side of the natural axis of the coated piston ring.

With all 6 parameters, i.e. the three thermal expansion coefficients and the three dimensions of thickness of the piston ring, of the wear protection layer and of the intermediate layer any desired bimetal effect may be compensated or evened out.

According to the invention this is achieved in that a piston ring (e.g. cast iron or steel) is first coated on the outside with an intermediate layer, having a higher thermal expansion coefficient than the material of the piston ring. In a second step a wear protection layer is applied on the outer side of the intermediate layer, wherein the wear protection layer has a lower thermal expansion coefficient than the material of the piston ring. It may be advantageous, if the thicknesses of the intermediate layer and of the wear protection layer are substantially smaller than the overall thickness of the piston ring.

The present invention represents nearly a combination of two identical bimetal combinations, wherein the effects of which balance or even out. The present invention uses a double coating of a piston ring. The effects between the piston ring and the wear protection layer on one hand and the effects between the wear protection layer and the intermediate layer on the other hand may be selected in a way that the piston ring shows a desired temperature behavior.

According to a first aspect of the present invention a piston ring for an internal combustion engine is provided. The piston ring comprises a piston ring base element of a material having a first thermal expansion coefficient. The piston ring comprises a wear protection layer arranged on a radially outer surface of the piston ring. The wear protection layer consists of a material having a second thermal expansion coefficient that is smaller than the first thermal expansion coefficient. Additionally, the piston ring comprises an intermediate layer arranged between the piston ring base element and the wear protection layer. The intermediate layer consists of a material having a third thermal expansion coefficient that is larger than the first thermal expansion coefficient and the second thermal expansion coefficient.

In another embodiment, the thickness of the wear protection layer is smaller than the thickness of the intermediate layer and the sum of the thicknesses of the wear protection layer and of the intermediate layer is smaller than 20% of the thickness of the piston ring base element in radial direction. With this it is ensured that both layers are located on the same side of the neutral axis of the piston ring, so that the effects may act oppositely with respect to each other.

Thus the piston ring forms a superposition of two, actually three bimetals. The first bimetal is formed between the wear protection layer and the piston ring base element, as known in the state of the art. The second bimetal is formed between the intermediate layer and the piston ring base element and is to work against the bimetal effect between the wear protection layer and the piston ring base element. The third bimetal is formed between the wear protection layer and the intermediate layer. The third bimetal should show the strongest effect as it is made of two metals with very different thermal expansion coefficients. However, the third bimetal may be neglected, due to the forces that may be generated by the two coatings, due to the low thicknesses of the wear protection layer and the intermediate layer as compared to the dimensions of the piston ring.

Preferable the intermediate layer is 1.5 times to 15 times thicker, preferably three times to 8 times and further preferred six times to 8 times thicker than the wear protection layer. The different thicknesses serve to compensate for the different strengths of the respective materials.

In an embodiment the intermediate layer is provided with a variation of the thickness in circumferential direction, to achieve a bimetal effect varying in the circumferential direction, to improve the distribution of the radial pressure. A variation of the thickness of the intermediate layer should be easier to work, due to the lower strength of the material (that is connected to the thermal expansion coefficient), than the material of the piston ring base element and of the material of the wear protection layer. Thus, during manufacture it is possible to work the intermediate layer during or after the application of the intermediate layer to show a variation in thickness in circumferential direction. Preferably, the intermediate layer is made to be thicker in the area of the gap, to stronger counteract the bimetal effect between the wear protection layer and the piston ring there.

In an embodiment the piston ring base element is provided in circumferential direction with a variation in thickness, to achieve a circumferentially varying bimetal effect, to thereby improving the distribution of the radial pressure. This embodiment may in particular serve in combination with a thicker intermediate layer to increase the bimetal effect between the intermediate layer and the piston ring base element on one hand and to increase the elasticity of the piston ring on the other hand. With a lower thickness of the piston ring in radial direction the piston ring becomes more flexible and the bimetal effect is increased.

In an additional embodiment the piston ring and/or the piston ring base element are formed un-round. The un-round form relates to the cold non-installed state. The un-round form serves so that the bimetal effect at operating temperature together with the inner wall of the cylinder give the piston ring a round form with a favorable distribution of radial pressure.

Preferably, the piston ring base element is made of a cast iron material or of a steel material. Cast iron materials or steel materials are actually the most common and the cheapest materials for piston rings.

The piston ring is preferably provided with a wear protection layer that has been applied by a PVD-Process.

Additionally, in one example embodiment the intermediate layer is made of copper or of a copper material. Due to its material properties such as the melting point of approximately 1000° C. copper is sufficiently heat resistant. Copper shows a fracture strain of 40% which is also in a favorable range to avoid the formation of fractures between the intermediate layer and the wear protection layer or the piston ring base element.

In an embodiment the wear protection layer is only applied to a part of the external surface as seen in an axial direction of the piston ring base element or the intermediate layer, respectively. Additionally it is envisaged to provide the intermediate layer only on a part of the outer surface of the piston ring or to remove it after it has been applied. Thus, the present invention may also be used especially with oil scraping rings.

In an additional embodiment the first thermal expansion coefficient is between 8 to 12*10⁻⁶/K, the second thermal expansion coefficient being between 2 to 5*10⁻⁶/K and the third thermal expansion coefficient being between 16 to 90*10⁻⁶/K. In these ranges favorable effects are expected, avoiding the current problems in connection with piston ring coatings.

Advantageously, a run-in layer is applied on the outside of the piston ring on the wear protection layer. Such a layer may positively influence the whole run-in process of the engine.

In the figures the invention is explained on the base of example embodiments.

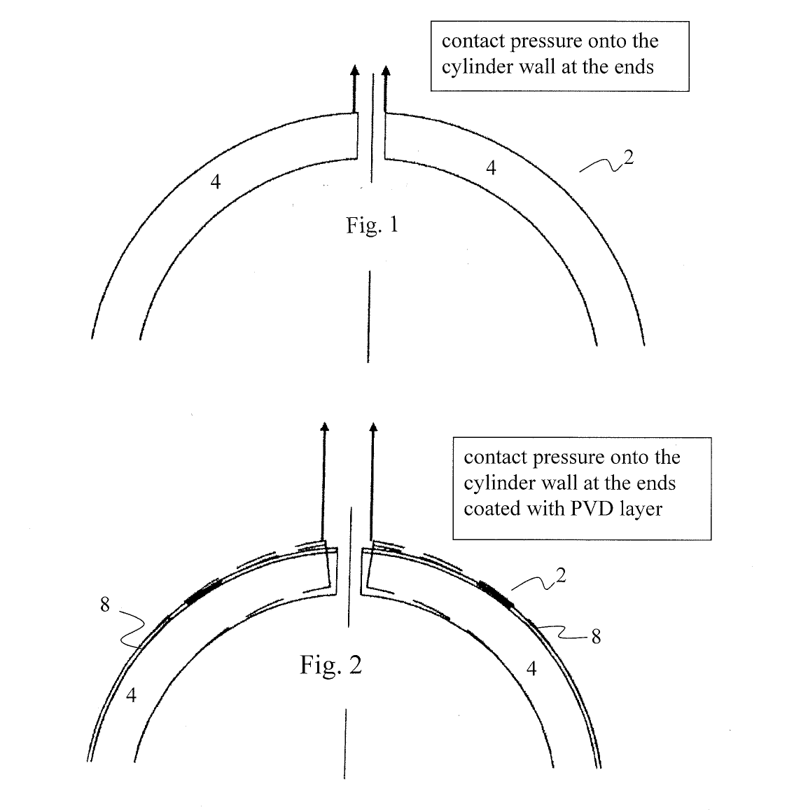

FIG. 1 shows a top view of a conventional piston ring.

FIG. 2 shows a top view of a conventional piston ring with a wear protection layer.

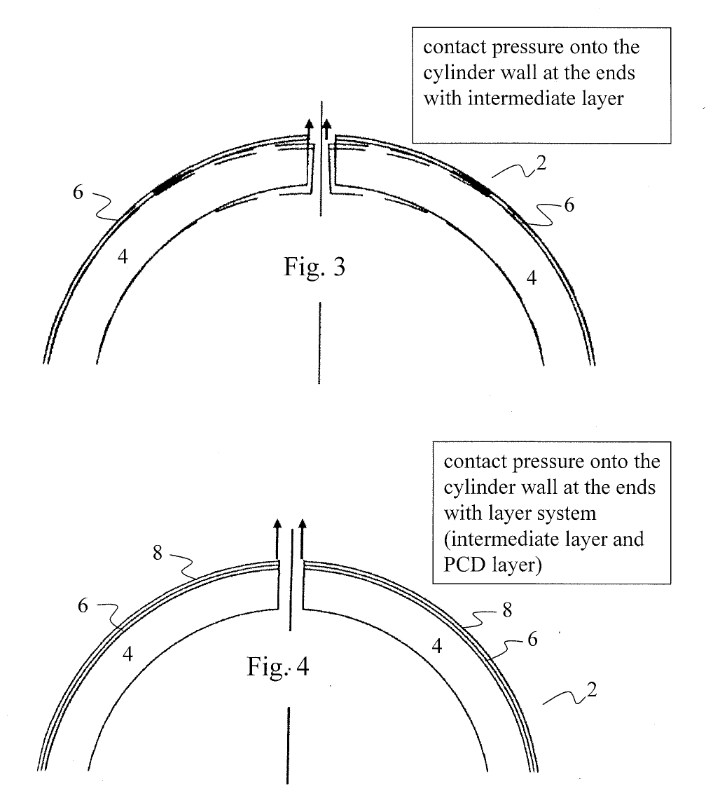

FIG. 3 shows a top view of a piston ring according to the present invention that is provided with an intermediate layer.

FIG. 4 shows a top view of a piston ring according to the present invention having a wear protection layer and an intermediate layer.

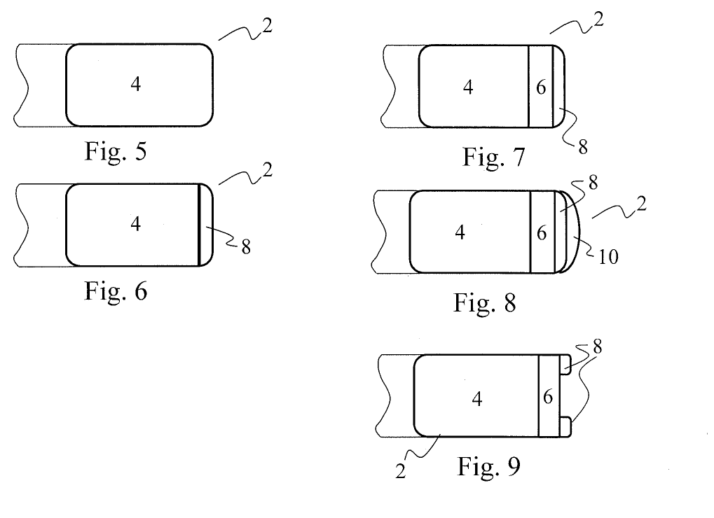

FIG. 5 shows a cross sectional view of a conventional piston ring.

FIG. 6 shows a cross sectional view of a conventional piston ring having a wear protection layer.

FIG. 7 shows a cross sectional view of a piston ring according to the present invention, provided with a wear protection layer and an intermediate layer.

FIG. 8 shows a cross sectional view of the piston ring of FIG. 7 provided with an additional run-in layer.

FIG. 9 shows an additional embodiment of the piston ring of FIG. 7, wherein the wear protection layer is only provided part of the outer surface of the piston ring.

In the following detailed description of the figures same reference signs are used for same or similar elements or components in the specification as well as in the figures. The figures are only for illustration and are not to scale, but only represent schematic depictions.

FIG. 1 shows a top view of a conventional piston ring 2 made from one material without any coating. The piston ring base element 2 is nearly a closed circular arc. The ends 2 at the gap the piston ring exert a small force onto the inner wall of the cylinder, as indicated by the short arrows. The piston ring shows no bimetal effect, therefore this force does not change significantly, in case of rising temperatures or if the operation temperature is reached.

FIG. 2 shows a top view of a conventional piston ring 2 of one material and with a wear protection layer 8. This piston ring 2 has a PVD-wear protection layer 8 that is applied onto the piston ring base element 4. The wear protection layer 8 is stronger and harder than the material of the piston ring base element 4. Thus, it has a lower thermal expansion coefficient than the material of the piston ring base element 4. In case of an increasing temperature a bimetal effect occurs at the ends of the piston ring, urging them outside, leading to an increased wear of the ends of the piston ring. Due to this increased wear there is a danger of piston seizure, leading to a destruction of the engine, as the increased contact pressure at the ends of the piston ring may not be absorbed by the lubricating film of the cylinder inner wall. The ends of the piston ring 2 exert a strong force onto the inner wall of the cylinder, as indicated by the longer arrows. Compared to a cold piston ring, this force is considerably increased.

This effect is shown in FIG. 2 by the interrupted indication of the piston ring at operation temperature. The longer arrows at the ends of the piston ring visualize the higher contact pressure of the ends of the piston ring onto the inner wall of the cylinder.

It is possible to work against this effect by plastic deformation of the piston ring, which is however in many cased not sufficient. The piston ring is pre-formed so that the deformation caused by the bimetal effect is evened out when heated to the operation temperature.

FIG. 3 shows a top view of a conventional piston ring 2 made of one material with only one intermediate layer 6. On this piston ring a copper layer 8 is applied onto the piston ring base element 4. The intermediate layer 6 has a lower strength than the material of the piston ring base element 4. Thus, it also has a higher thermal expansion coefficient than the material of the piston ring base element 4. On heating, a bimetal effect occurs especially at the ends of the piston ring, urging them inwardly, leading to a reduced wear at the ends of the piston ring. The intermediate layer may counteract the increased wear at the piston ring ends. The intermediate layer consists of a softer or lower strength material than the one, the piston ring is made of, thus is abrades quickly at the whole circumference, leading in turn to an increased wear.

As indicated by the short arrows, the ends of the piston ring 4 only provided with an intermediate layer 6 exert only a low force on the inner wall of the cylinder. This force is reduced in case of warming or when reaching the operation temperature.

This effect is indicated in FIG. 3 by the interrupted depiction of the piston ring at operation temperature. The shorter arrows at the ends of the piston ring visualize the reduced contact force of the ends of the piston rind onto the inner wall of the cylinder. The interrupted lines show a deformation of the piston ring in case of warming.

FIG. 4 shows a piston ring 2 according to the invention from one material having a wear protection layer and an intermediate layer. In this embodiment an intermediate layer 6 and a PVD-wear protection layer 8 are applied onto the piston ring base element 4. The bimetal effects described above may just even out, if suitable material constants and suitable thicknesses of the layers are selected. Therewith the contact pressure of the ends of the piston ring may be kept on a desired level at all temperature ranges. Simultaneously, the operation time of the piston ring and thus the one of the engine may be increased. With the present invention it is possible to achieve the advantages of a piston ring having a wear protection layer without having to accept the usual drawbacks of increased contact pressure. Another advantage of the present invention resides in that only the outer surfaces of the piston ring have to be coated, which according to the manufacturing method, may present a significant simplification of the manufacturing process.

FIG. 5 shows a conventional piston ring or of a piston ring base element 2, i.e., the piston ring of FIG. 1 in a cross section.

FIG. 6 shows a conventional piston ring having a piston ring base element 2 and a wear protection layer 8, i.e. piston ring of FIG. 2 in a cross section.

FIG. 7 shows a cross sectional view of a piston ring 2 according to the present invention, wherein an intermediate layer 6 and a wear protection layer 8 are applied onto the piston ring base element 8.

FIG. 8 shows a cross sectional view of the piston ring of FIG. 7 having an additional run-in layer 10.

FIG. 9 shows the piston ring of FIG. 7 in an additional embodiment wherein the wear protection layer 8 is only applied onto a part of the outer surface of the piston ring 2. This embodiment is especially suitable for oil scraping rings only contacting the cylinder inner wall with 2 or 3 ridges, to create a defined oil film on the cylinder inner wall.

The representations in the figures are only schematic and do not express the actual proportions. Additional combination of the described embodiments should also be considered as disclosed.

1. A piston ring for an internal combustion engine, comprising:
a piston ring base element made of a material having a first thermal expansion coefficient,
a wear protection layer, arranged on a radially outer face of the piston ring and being made of a material having a second thermal expansion coefficient that is smaller than the first thermal expansion coefficient, and including
an intermediate layer, arranged between the piston ring basis element and the wear protection layer, wherein the intermediate layer is made of a material having a third thermal expansion coefficient, that is bigger than the first thermal expansion coefficient.

2. The piston ring according to claim 1, wherein a thickness of the wear protection layer is smaller than a thickness of the intermediate layer, and the thickness of the wear protection layer and the thickness of the intermediate layer are smaller than 20% of the thickness of the piston ring basis element in radial direction.

3. The piston ring according to claim 1 wherein there is a variation of thickness of the intermediate layer in circumferential direction.

4. The piston ring according to claim 1, wherein there is a variation of thickness of the piston ring base element in circumferential direction.

5. The piston ring according to claim 1, wherein at least one of the piston ring and piston ring base element is formed non-circular.

6. The piston ring according to claim 1, wherein the piston ring basis element consists of a cast iron or steel material.

7. The piston ring according to claim 1, wherein the wear protection layer is applied by a PVD-method.

8. The piston ring according to claim 1, wherein the intermediate layer consists of copper or of a copper containing material.

9. The piston ring according to claim 1, wherein the wear protection layer is applied in axial direction only to a part of the outer surface of the piston ring basis element and the intermediate layer, respectively.

10. The piston ring according to claim 1, wherein the first thermal expansion coefficient is between 8 to 12*10⁻⁶/K, the second thermal expansion coefficient is between 2 to 5*10⁻⁶/K, and the third thermal expansion coefficient is 16 to 90*10⁻⁶/K.

11. The piston ring according to claim 1, further comprising a run-in layer, arranged on the outer side of the wear protection layer.
